(19) United States
(12) Patent Application Publication
(10) Pub. No.: US 2018/0063590 A1
(43) Pub. Date: Mar. 1, 2018

(54) Systems and Methods for Encoding and Playing Back 360° View Video Content

(71) Applicant: Sonic IP, Inc., San Diego, CA (US)

(72) Inventors: Horngwei Michael Her, Saint James, NY (US); Yuri Bulava, Tomsk (RU)

(73) Assignee: Sonic IP, Inc., San Diego, CA (US)

(21) Appl. No.: 15/691,585

(22) Filed: Aug. 30, 2017

Related U.S. Application Data
(60) Provisional application No. 62/381,485, filed on Aug. 30, 2016.

(51) Int. Cl. H04N 21/472; H04N 21/44; H04N 21/81; H04N 21/442

(52) U.S. Cl. CPC H04N 21/47217; H04N 21/44209; H04N 21/8146; H04N 21/44008

(57) ABSTRACT

Systems and methods for encoding and playing back 360° view content are disclosed. The systems and methods may obtain streams of video content two or more cameras that each has a different view point. The received video content can be provided to one or more encoders that encode the video content into alternatives streams and generate index information for each of alternative streams. The alternative streams include a first set of streams that include video content for a first view point and are each encoded at different maximum bit rates and a second set of streams that include video content from a second view point and are each encoded at different maximum bit rates.

### CROSS-REFERENCE TO RELATED APPLICATIONS

The current application claims priority to U.S. Provisional Patent Application No. 62/381,485, filed Aug. 30, 2016, the disclosure of which is incorporated herein by reference as if set forth herewith.

### FIELD OF THE INVENTION

The present invention generally relates to adaptive streaming and more specifically to systems that encode video data from live events captured by two or more cameras into feeds for each camera view. The present invention also generally relates to playback devices that use the streams to obtain encoded video content for playback.

### BACKGROUND

The term streaming media describes the playback of media on a playback device, where the media is stored on a server and continuously sent to the playback device over a network during playback. Typically, the playback device stores a sufficient quantity of media in a buffer at any given time during playback to prevent disruption of playback due to the playback device completing playback of all the buffered media prior to receipt of the next portion of media to playback. Adaptive bit rate streaming or adaptive streaming involves detecting the present streaming conditions (e.g. the user's network bandwidth and CPU capacity) in real time and adjusting the quality of the streamed media accordingly. Typically, the source media is encoded at multiple bit rates and the playback device or client switches between streams having different encodings depending on available resources.

Adaptive streaming solutions typically utilize either Hypertext Transfer Protocol (HTTP), published by the Internet Engineering Task Force and the World Wide Web Consortium as RFC 2616, or Real Time Streaming Protocol (RTSP), published by the Internet Engineering Task Force as RFC 2326, to stream media between a server and a playback device. HTTP is a stateless protocol that enables a playback device to request a byte range within a file. HTTP is described as stateless, because the server is not required to record information concerning the state of the playback device requesting information or the byte ranges requested by the playback device in order to respond to requests received from the playback device. RTSP is a network control protocol used to control streaming media servers. Playback devices issue control commands, such as “play” and “pause”, to the server streaming the media to control the playback of media files. When RTSP is utilized, the media server records the state of each client device and determines the media to stream based upon the instructions received from the client devices and the client's state.

In adaptive streaming systems, the source media is typically stored on a media server as a top-level index file or manifest pointing to a number of alternate streams that contain the actual video and audio data. Each stream is typically stored in one or more container files. Different adaptive streaming solutions typically utilize different index and media containers. The Synchronized Multimedia Integration Language (SMIL) developed by the World Wide Web Consortium is utilized to create indexes in several adaptive streaming solutions including IIS Smooth Streaming developed by Microsoft Corporation of Redmond, Wash., and Flash Dynamic Streaming developed by Adobe Systems Incorporated of San Jose, Calif. HTTP Adaptive Bitrate Streaming developed by Apple Computer Incorporated of Cupertino, Calif. implements index files using an extended M3U playlist file (.M3U8), which is a text file containing a list of URLs that typically identify a media container file. The most commonly used media container formats are the MP4 container format specified in MPEG-4 Part 14 (i.e. ISO/IEC 14496-14) and the MPEG transport stream (TS) container specified in MPEG-2 Part 1 (i.e. ISO/!EC Standard 13818-1). The MP4 container format is utilized in IIS Smooth Streaming and Flash Dynamic Streaming. The TS container is used in HTTP Adaptive Bitrate Streaming.

The Matroska container is a media container developed as an open standard project by the Matroska non-profit organization of Aussonne, France. The Matroska container is based upon Extensible Binary Meta Language (EBML), which is a binary derivative of the Extensible Markup Language (XML). Decoding of the Matroska container is supported by many consumer electronics (CE) devices. The DivX Plus file format developed by DivX, LLC of San Diego, Calif. utilizes an extension of the Matroska container format (i.e. is based upon the Matroska container format, but includes elements that are not specified within the Matroska format).

To provide a consistent means for the delivery of media content over the Internet, the International Organization for Standardization (ISO) and the International Electrotechnical Commission (IEC) have put forth the Dynamic Adaptive Streaming over HTTP (DASH) standard. The DASH standard specifies formats for the media content and the description of the content for delivery of MPEG content using HTTP. In accordance with DASH, each component of media content for a presentation is stored in one or more streams. Each of the streams is divided into segments. A Media Presentation Description (MPD) is a data structure that includes information about the segments in each of the stream and other information needed to present the media content during playback. A playback device uses the MPD to obtain the components of the media content using adaptive bit rate streaming for playback.

As the speed and bandwidth of network connections have increased, the Over The Top (OTT) transmission of live events such as, but not limited to, sporting contests and concerts, have become a common means for users to watch the event. Most live events have always been captured by more than one camera and/or microphone. Post-processing is then used to select the video from a single camera to present for the broadcast of the event. This restricts a viewer to the view from a single camera that is selected by a producer(s) of the broadcast. However, sometimes users want to be able to select a camera view that shows other content. For example, a user may want to focus on watching a particular player or portion of the playing field during the game that may not be shown by the video content from the camera selected by the producer. Thus, a viewer would get more satisfaction watching the event if the user select a view from the video content from a different camera or combinations of cameras.

### SUMMARY OF THE INVENTION

Systems and methods in accordance with embodiments of the invention provide adaptation sets for each of a number of different viewpoints that enable selection of an adaptation set based upon the viewpoint of a playback device and adaptive bitrate streaming of video from the selected viewpoint based upon the capacity of the network and/or playback device.

On embodiment of the invention includes: a processor; memory accessible by the processor; and instructions stored in the memory that direct the processor to: request video content from a content provider system; receive a manifest including information for retrieving plurality of alternative streams of video content from a content provider system, wherein each of a plurality of alternative streams includes segments of video content for one of a plurality of views of the video content and is encoded at a specific maximum bit rate; determine a network bandwidth for communications between the playback device and content provider system; determine a desired view of the video content; determine one of the plurality of alternative streams to use for streaming based on the determined network bandwidth and the desired view and the information for the plurality of alternative streams in the manifest; request segments of video content from the determined one of the plurality of alternative streams based on information for the one of the plurality of alternative streams in the manifest from the content provider system; receive the requested segments from the determined one of the plurality of alternative streams from the content provider system in response to the request; and playback the received segments.

In a further embodiment, the instructions further direct the processor to: monitor communications between the playback device and the content provider system; detect a change in the network bandwidth to a new network bandwidth based on the monitored communications; determine a second one of the plurality of alternative streams to use for streaming based on the new network bandwidth and the desired view using the manifest; request segments of the video content from the second one of the plurality of alternative streams from the content provider system based on information for the second one of the plurality of alternative streams in the manifest from the content provider system; receive the requested segments from the second one of the plurality of alternative streams from the content provider system in response to the request; and playback the received segments.

In another embodiment, the instructions further direct the processor to: determine a change in view of the video content to a second view is desired; determine a second one of the plurality of alternative streams to use for streaming based on the network bandwidth and the second view using the manifest; request segments of the video content from the second one of the plurality of alternative streams from the content provider system based on information for the second one of the plurality of alternative streams in the manifest; receive the requested segments of the second one of the plurality alternative streams from the content provider system in response to the request; and playback the received segments.

In a still further embodiment, the determining of the view is based upon detected movement of the playback device.

In still another embodiment, the determining of the view is based upon an image of the playback device captured from another device to determine point of view.

In a yet further embodiment, the determining of the view is based upon metadata received with the video content.

An embodiment of the method of the invention includes: requesting video content from a content provider system using the playback device; receiving a manifest including information for retrieving a plurality of alternative streams of video content in the playback from a content provider system, device wherein each of a plurality of alternative streams includes segments of video content for one of a plurality of views of the video content and is encoded at a specific maximum bit rate; determining a network bandwidth for communications between the playback device and content provider system using the playback device; determining a desired view of the video content using the playback device; determining one of the plurality of alternative streams to use for streaming based on the determined network bandwidth, the desired view, and the information for the plurality of alternative streams in the manifest using the playback device; requesting segments of video content from the determined one of the plurality of alternative streams based on information for the one of the plurality of alternative streams in the manifest from the content provider system using the playback device; receiving the requested segments of the one of the plurality of alternative streams from the content provider system in the playback device in response to the request; and playing back the received segments using the playback device.

Another embodiment includes: monitoring communications between the playback device and the content provider system using the playback device; detecting a change in the network bandwidth to a new network bandwidth using the playback device; determining a second one of the plurality of alternative streams to use for streaming based on the new network bandwidth and the desired view using the manifest using information in the manifest; requesting segments of the video content from the second one of the plurality of alternative streams from the content provider system based on information for the second one of the plurality of alternative streams in the manifest using the playback device; receiving the requested segments of the second one of the plurality of alternative streams from the content provider system in the playback device in response to the request; and playing back the received segments using the playback device.

A further embodiment includes: determining a change in view of the video content to a second view is desired using the playback device; determining a second one of the plurality of alternative streams to use for streaming based on the network bandwidth and the second view based on information in the manifest the manifest using the playback device; requesting segments of the video content from the second one of the plurality of alternative streams from the content provider system based on information for the second one of the plurality of alternative streams in the manifest using the playback device; receiving the requested segments of the second one of the plurality of alternative streams from the content provider system in the playback device in response to the request; and playing back the received segments using the playback device.

In still another embodiment, the determining of the view is based upon detected movement of the playback device.

In a yet further embodiment, the determining of the view is based upon an image of the playback device captured from another device to determine point of view.

In yet another embodiment, the determining of the view is based upon metadata received with the video content.

Another further embodiment includes: requesting video content from a content provider system; receiving a manifest including information for retrieving a plurality of alternative streams of video content from a content provider system, wherein each of a plurality of streams includes segments of video content for one of a plurality of views of the video content and is encoded at a specific maximum bit rate; determining a network bandwidth for communications between the playback device and content provider system; determining a desired view of the video content; determining one of the plurality of alternative streams to use for streaming based on the determined network bandwidth, the desired view, and the information for the plurality of alternative streams in the manifest; requesting segments of video content from the determined one of the plurality of alternative streams based on information for the one of the plurality of alternative streams in the manifest from the content provider system; receiving the requested segments of the one of the plurality of alternative streams from the content provider system in response to the request; and playing back the received segments.

Still another further embodiment includes: a processor; a memory accessible by the processor; and instructions stored in memory that direct the processor to: obtain at least one stream of video content containing video captured by one of a plurality of cameras and each of the plurality of cameras has a different view point; provide video content from the at least one stream to a plurality of encoders wherein the plurality of encoders encode each of a plurality of separate viewpoints from within the video content into an adaptation set comprising a plurality of alternatives streams; generate index information for the adaption set corresponding to each of the plurality of separate viewpoints; store each of the generated adaptation sets in memory; and store the manifest information for each adaptation set in a manifest, where the manifest indicates a maximum bitrate for each of the plurality of streams in an adaptation set and a viewpoint for each adaptation set.

In yet another further embodiment, the instructions to obtain the plurality of streams of video content include instructions to: receive a source stream of video content captured by the plurality of cameras; divide the source stream into a plurality of streams wherein each of the plurality streams includes video content from one of the plurality of cameras. In addition, the plurality of streams of the video content from the plurality of cameras are provided to the encoders.

In another further embodiment again, the instructions to obtain the plurality of streams of video content include instructions to: receive a source stream of video content captured by the plurality of cameras; generate 360° degree view video content from the video content of the source stream; and divide the 360° degree view video content into a plurality of tiles wherein each of the plurality of tiles is a stream of video content from a specific viewpoint. In addition, the plurality of tiles are provided to the encoders.

In another further additional embodiment, the instructions to obtain the plurality of streams include instructions to receive each of the plurality of streams for one of the plurality of cameras and wherein each of the received plurality of streams is provided to the plurality of encoders.

In a further embodiment again, the instructions that direct the processor further include instructions to provide an encoder that receives an input stream of video content and outputs video content for a plurality of alternative streams wherein each of the plurality alternative streams is encoded at a different maximum bit rate and the instructions to provide the encoder are scalable to the plurality of encoders by instantiating a plurality of encoders from the instructions to provide the encoder.

In another embodiment again, the plurality of streams of video content provided to the plurality of encoders include timing information for the video content and the encoding of the video content into a plurality of alternative streams by the plurality of encoders is synchronized based on the timing information in the plurality of streams of video content.

A still further embodiment again includes: obtaining at least one stream of video content containing video captured by one of a plurality of cameras and each of the plurality of cameras has a different view point; providing video content from the at least one stream to a plurality of encoders wherein the plurality of encoders encode each of a plurality of separate viewpoints from within the video content into an adaptation set comprising a plurality of alternatives streams; generating index information for the adaption set corresponding to each of the plurality of separate viewpoints; storing each of the generated adaptation sets in memory; and storing the manifest information for each adaptation set in a manifest, where the manifest indicates a maximum bitrate for each of the plurality of streams in an adaptation set and a viewpoint for each adaptation set.

In still another embodiment again, the obtaining of the plurality of streams of video content includes: receiving a source stream of video content captured by the plurality of cameras in the encoding system; and dividing the source stream into a plurality of streams using the encoding system wherein each of the plurality streams includes video content from one of the plurality of cameras. In addition, the plurality of streams of the video content from the plurality of cameras are provided to the encoders.

In a further additional embodiment, the obtaining of the plurality of streams of video content includes: receiving a source stream of video content captured by each of the plurality of cameras in the encoding system; generating 360° degree view video content from the video content of the source stream using the encoding system; and dividing the 360° degree view video content into a plurality of tiles using the encoding system wherein each of the plurality of tiles is a stream of video content from a particular view. In addition, the plurality of tiles are provided to the encoders.

In another additional embodiment, the obtaining of the plurality of streams includes receiving each of the plurality of streams for one of the plurality of cameras in the encoder system and wherein each of the received plurality of streams is provided to the plurality of encoders.

In a still yet further additional embodiment, the plurality of streams of video content provided to the plurality of encoders include timing information for the video content and the encoding of the video content into a plurality of alternative streams by the plurality of encoders is synchronized based on the timing information in the plurality of streams of video content.

### BRIEF DESCRIPTION OF THE DRAWINGS

FIG. 1 illustrates a network diagram of an adaptive bitrate streaming system for providing OTT transmission of video content of a live event from different cameras and/or views in accordance with an embodiment of the invention.

FIG. 2 illustrates a block diagram of components of an encoder system that encodes video content from two or more cameras and/or views in accordance with an embodiment of the invention.

FIG. 3 illustrates a block diagram of components of a processing system in a playback device that uses the encoded streams having different maximum bitrates to obtain the video content via adaptive bitrate streaming in accordance with an embodiment of the invention.

FIG. 4 illustrates a block diagram of components of a processing system in an encoder server system that encodes the video content into streams having different maximum bitrates in accordance with an embodiment of the invention.

FIG. 5 illustrates a flow diagram for a process performed by an encoder server system to encode video content from one or more feeds each representing a view into alternative streams used in an adaptive bitrate streaming system in accordance with an embodiment of the invention.

FIG. 6 illustrates a flow diagram for a process performed by each encoder in an encoder server system to encode each segment of the video content of one or more particular feed(s) into alternative streams in accordance with an embodiment of the invention.

FIG. 7 illustrates a flow diagram of a process performed by a playback device to obtain the manifest information for the alternative streams and use the alternative streams to obtain the video content using an adaptive bitrate system in accordance with an embodiment of the invention.

### DETAILED DESCRIPTION

Turning now to the drawings, systems and methods for encoding video content from two or more cameras and/or views into alternative streams for adaptive bitrate steaming and obtaining the content using a playback device in accordance with some embodiments of the invention are illustrated. In accordance with some embodiments of this invention, an encoding system includes one or more encoders. In accordance with some of these embodiments, the encoders maybe provided by software executed by a processing system in the encoding system. In accordance with many embodiments, the encoders may be provided by firmware in the encoding system. In accordance with a number of embodiments, the encoders are provided by hardware in the encoding system.

The encoding system receives at least one source stream of video content from two or more cameras. Video content from each camera can be synchronized with content from the other camera(s) using timestamps. In accordance with some embodiments, the video content may be a live feed being recorded in real-time. In accordance with many embodiments, the source stream of video content from each camera can include a timestamp in accordance with universal time.

In accordance with some embodiments, the video content from the two or more cameras is processed to generate views from one or more different viewpoints. In accordance with many embodiments, the video content from the two or more cameras can be used to generate a single 3D video content that may be then divided into tiles.

In accordance with some embodiments, segments of video content from each of the two or more cameras and/or generated video content from different viewpoints is provided to the source encoding system. In accordance with many embodiments, the segments may be provided to the source encoding system in real-time as the video content is being captured by the different cameras. The source encoding system can receive the segments of video content from each of the two or more cameras and/or the generated content with different views and may provide the segments from each particular camera and/or view to a particular encoder or group of encoders that generate the alternative streams for each camera and/or view. These alternative streams are sometimes referred to as adaptation sets in the context of adaptive bitrate streaming. Each particular encoder and/or particular group of encoders can encode each segment of the video content into the various alternative streams used to support adaptive bit rate streaming. In accordance with some embodiments, each stream produced for the video content from a particular camera and/or for a particular view has a different maximum bitrate (or different target average bitrate) than the one or more of the other alternative streams generated for the video content of the particular camera and/or view. In accordance with many embodiments, other parameters including, but not limited to, aspect ratio, resolution, and frame rate may be varied in the streams being generated for video content from each particular camera and/or view.

Each encoder and/or group of encoders stores the segments generated for each particular stream in one or more container files for the particular stream in accordance with some embodiments of the invention. The encoder can also generate index or manifest information for each of the generated portions of the streams for the video content from each camera and/or view. The generated index manifest information may be added to an index file or manifest in accordance with a number of embodiments of the invention. The process may repeated until the end of the source streams from the cameras and/or views are received.

In accordance with many embodiments, the media content for each camera and/or view can be stored in streams in accordance with the MPEG-DASH standard involving the encoding of the content in accordance with the H.265/HEVC or H.264/AVC encoding standards and stored in the ISO container file format. In many embodiments, the content stored in the container files in encrypted in accordance with the Common Encryption Format specified by MPEG. However, other formats such as, but not limited to, a Matroska (MKV) container file format may be used to store streams of the media content in accordance with various embodiments of the invention.

The performance of an adaptive bitrate streaming system in accordance with some embodiments of the invention can be significantly enhanced by encoding each portion of the source video in each of the alternative streams in such a way that a segment of video is encoded in each stream as a single (or at least one) closed group of pictures (GOP) starting with an Instantaneous Decoder Refresh (IDR) frame that is an intra frame. During playback, a playback device can switch between the alternative streams used at the completion of the playback of a video segment irrespective of the stream from which a video segment is obtained because the first frame of the next video segment will be an IDR frame that can be decoded without reference to any encoded media other than the encoded media contained within the video segment.

In a number of embodiments, the playback device obtains information concerning each of the available streams of video content for each of the cameras and/or views from the MPD. The playback device may then select one or more streams to utilize in the playback of the video content. The playback device may also request index information that indexes segments of the encoded video content stored within the relevant container files. The index information can be stored within the container files or separately from the container files in the MPD or in separate index files. The index information can enable the playback device to request byte ranges of video content corresponding to segments of the encoded video content within the container file (or entire container files) containing specific portions of encoded video content via HTTP (or another appropriate stateful or stateless protocol) from the server of a content provider. Playback is continued with the playback device requesting segments of the encoded video content from a stream having video content for a particular camera/view that is encoded at a maximum bitrate that can supported by the network conditions and/or the properties of the playback device.

In accordance with some embodiments of the invention, the playback device may operate in the following manner to use the streams of video content from the different cameras and/or different views generated by the multiple encoders in the encoding system. The playback device can request the media content that includes the video content. In response to the request, the playback device can receive the MPD or index file maintained for the media content. The playback device can use the index information from the MPD to perform adaptive bitrate streaming to obtain the video content from a selected camera and/or view. During viewing of the content, the playback device can switch to alternative sets of adaptive streams based upon a change in a viewing direction. In this way, so called “360 degree” video can be encoded as a series of tiles that can each be delivered via adaptive bitrates streaming and the playback device can choose between streams based upon a stream switching decision engine that determines streams to select based upon viewing direction and available bandwidth and/or processing power.

Systems and methods for encoding of video content from two or more cameras and/or different views for use in adaptive bitrate streaming and obtaining the video content from the generated streams via adaptive bitrate streaming in accordance with several embodiments of the invention are discussed further below.

### Adaptive Streaming Architecture

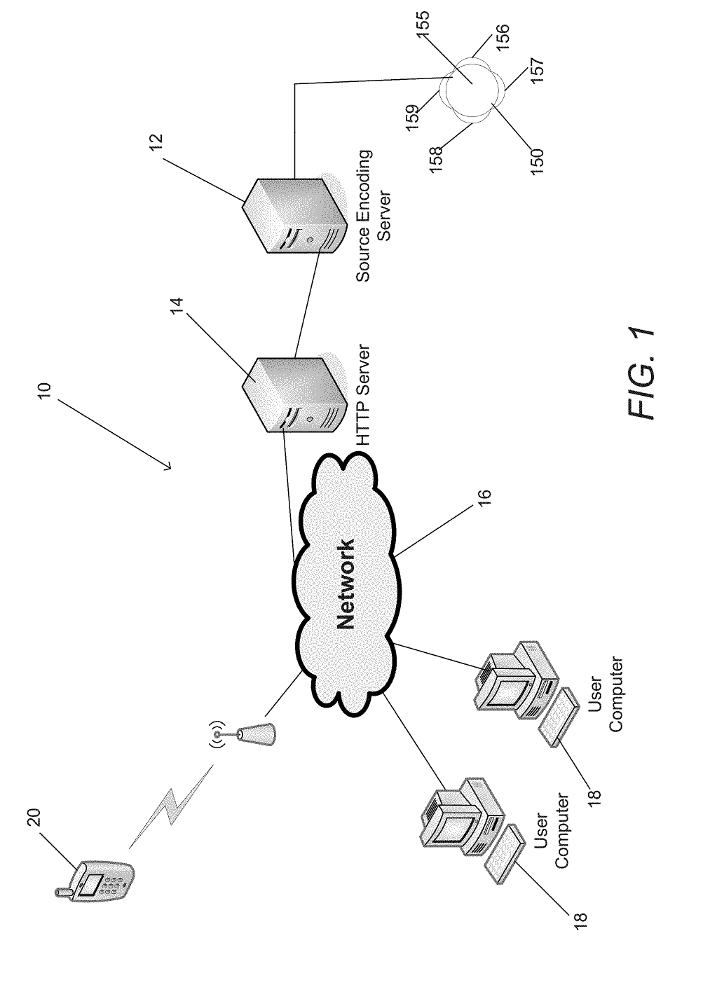

An adaptive bit rate streaming system that includes an encoding system that generates alternative streams for video content captured by two or more cameras and/or different views in accordance with an embodiment of the invention is illustrated in FIG. 1. The adaptive streaming system 10 includes a source encoding system 12 configured to encode source media content including video content captured by two or more cameras and/or different views generated from the captured content as a number of alternative streams. In the illustrated embodiment, the source encoder is a single server. In accordance with many embodiments, the source encoder can be any processing device or group of processing devices including a processor and sufficient resources to perform the transcoding of source media (including but not limited to video, audio, and/or subtitles) into the alternative streams. Typically, the source encoding server 12 generates an MPD that includes an index indicating container files containing the streams and/or metadata information. In many embodiments, at least two of the streams identified in the index (e.g. MPD file) are alternative streams of video content captured by a single camera and/or from a single viewpoint. Alternative streams are streams that encode the same media content in different ways. In many instances, alternative streams encode video content at different maximum bitrates. In accordance with a number of embodiments, the alternative streams of video content can also be encoded with different resolutions, different frame rates, and/other varying video parameters. However, the source encoder system 12 may use multiple encoders to generate the alternative streams and each particular encoder can generate index or manifest data (e.g. MPD data) for the segments of the stream or streams generated by the particular encoder. The MPDs or manifest information generated by the various encoders and the container files can be uploaded to an HTTP server 14. A variety of playback devices can then use HTTP or another appropriate stateless protocol to request portions of the MPDs, index files, and the container files via a network 16 such as the Internet.

In accordance with some embodiments of the invention, the source encoding system 12 obtains video and/or audio content from a connected camera system 150. Camera system 150 may include multiple cameras 155-159 that capture video content from different viewpoints. In accordance with many embodiments, camera system 150 may include a sufficient number of cameras to capture a 360° view of the environment based on the various viewing angles of the individual cameras 155-159. In accordance with several embodiments, individual camera system 155-159 may not be integrated into a single system and may be arranged and/or spaced apart in such a manner as to capture a scene from various different viewpoints. In accordance with some embodiments, the cameras 155-158 and/or camera system 150 may not be directly connected to the source encoding system 12. Instead, the cameras 155-159 and/or camera system 150 can be connected to source encoding system 12 via a network connection. In accordance with various embodiments, the network may be a Wide Area Network (WAN), a Local Area Network (LAN), or a Virtual Private Network (VPN) that uses the Internet. In accordance with a number of embodiments, the camera system 150 and/or cameras 155-159 may be connected by a wireless communication system to the source encoding network 12. In accordance with several embodiments, the camera system 150 is a Nokia OZO Camera System manufactured by Nokia Technologies of Finland.

In the illustrated embodiment, playback devices that can perform adaptive bitrate streaming using manifest data (e.g. MPD data) generated by the various encoders of source system 12 can include personal computers 18, CE players, and mobile phones 20. In accordance with many embodiments, the playback devices can also include consumer electronics devices such as DVD players, Blu-ray players, televisions, set top boxes, video game consoles, tablets, virtual reality headsets, augmented reality headsets and other devices that are capable of connecting to a server via a communication protocol including (but not limited to) HTTP and playing back encoded media.

Although a specific architecture is shown in FIG. 1, any of a variety of architectures including systems that perform conventional streaming (e.g. switching is only based upon changes of viewpoint) and not adaptive bitrate streaming can be utilized to allow playback devices to request and playback segments of video content in accordance with various embodiments of the invention.

### Encoder System

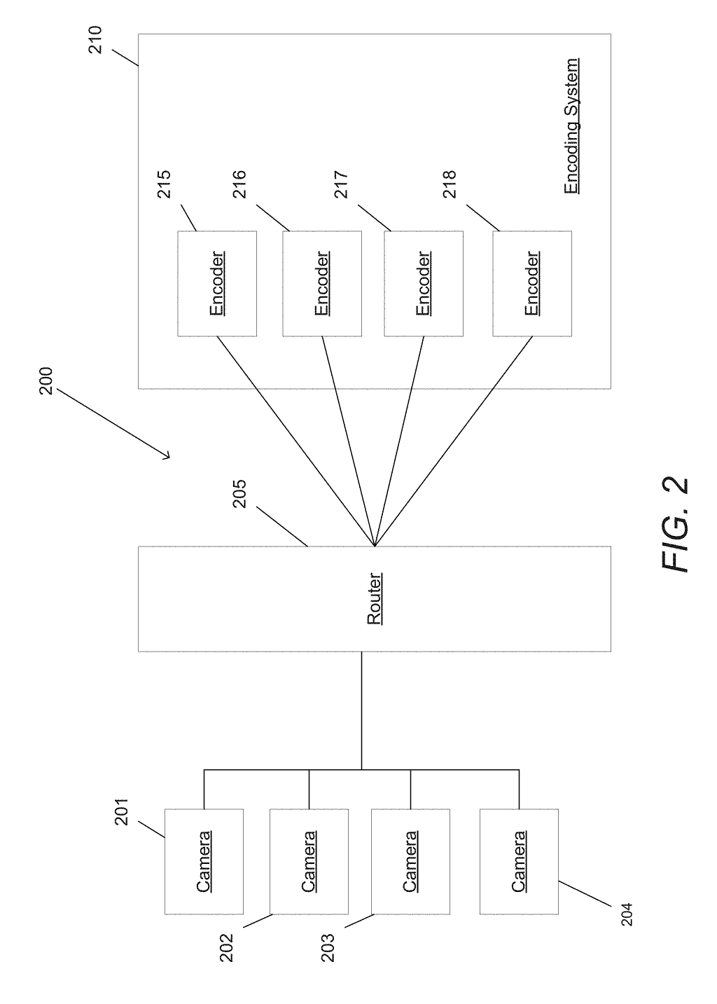

A source encoder system that uses multiple encoders to encode video content from two or more cameras and/or views into alternative streams for use in adaptive bitrate streaming in accordance with an embodiment of the invention is shown in FIG. 2. Source encoding system 200 includes a router 205 and an encoding server 210. The encoding server 210 is communicatively connected to the router 205. The router 205 may also be a server, any other system, or group of systems that performs similar functions in accordance with various embodiments of the invention. In FIG. 2, only one router is shown for clarity and brevity. The router 205 receives streams of video content from each of camera 201-204. In accordance with some embodiments, each camera 201-204 captures images of an event and generates a stream of content that includes timing information. In accordance with many embodiments, each camera 201-204 provides the video content captured by the camera to a camera system that generates the stream of video content with embedded timing information. The router 205 provides the streams of video content received from the cameras 201-204 to the encoder server 210.

The encoder server 210 includes multiple encoders 215-218. In accordance with some embodiments, each of the encoders 215-218 can be an instantiation of software that is being executed by the processor from instructions stored in a memory to perform the decoding and/or encoding of the source content. In accordance with many embodiments, each of the one or more of encoders 215-218 can each be a particular hardware component in the server that encodes received content. In a number of embodiments, one or more of the encoders may be a firmware component in which hardware and software are used to provide the encoder. In accordance with some embodiments, the router 205 can provide each incoming source stream of video content from cameras 201-204 to one of the encoders 215-218 of the server 210. In accordance with many embodiments, the router 205 may transmit portions of each stream from one of the cameras 201-204 to a more than one of the encoders 215-218. In accordance with a number of embodiments, the server 210 may receive the source streams from the router 205 and can provide a copy of each incoming source stream to a group of associated encoders as the source stream is received. The encoders 215-218 may then encode the streams of content into alternative streams and generate manifest information for streams as described below in more detail.

Although a specific architecture of a server system is shown in FIG. 2, any of a variety of architectures including systems that encode video content from streams of video content from two or more cameras can be utilized in accordance with various embodiments of the invention.

### Playback Device

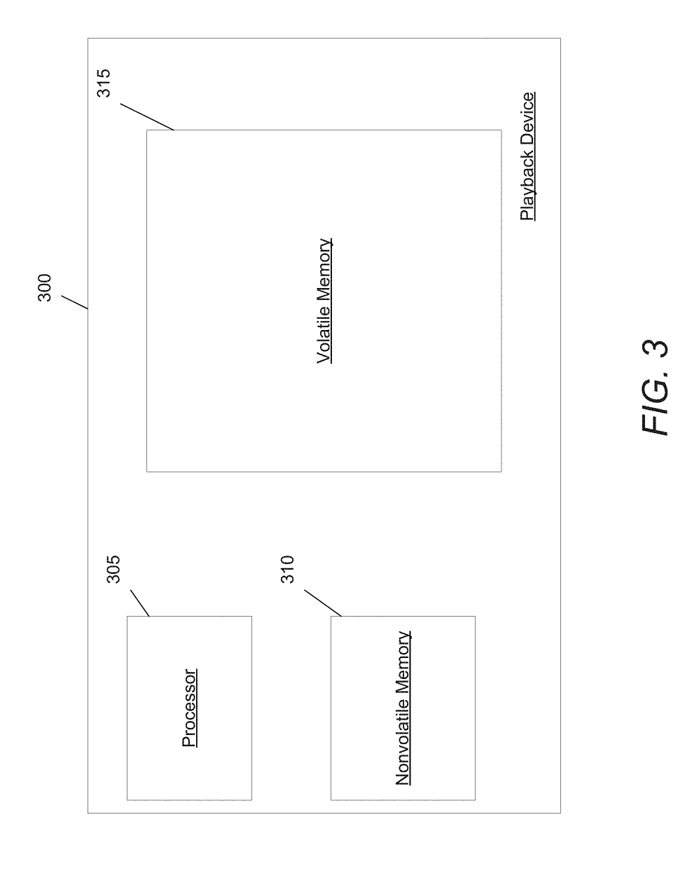

Processes for using the alternative streams for video content from different camera and/or views in accordance with some embodiments of this invention are executed by a playback device. The relevant components in a playback device that can perform the processes in accordance with an embodiment of the invention are shown in FIG. 3. Playback devices may include other components that are omitted for brevity without departing from various embodiments of this invention. In FIG. 3, the playback device 300 includes a processor 305, a non-volatile memory 310, and a volatile memory 315. The processor 305 may be a processor, microprocessor, controller, or a combination of processors, microprocessor, and/or controllers that performs instructions stored in the volatile memory 315 and/or non-volatile memory 310 to manipulate data stored in the memory. The non-volatile memory 310 can store the processor instructions utilized to configure the playback device 300 to perform processes including processes for using alternative streams encoded by multiple encoders to obtain video content using adaptive bit rate streaming in accordance with some embodiments of the invention. In accordance with various other embodiments, the playback device may have hardware and/or firmware that can include the instructions and/or perform these processes. In accordance with still other embodiments, the instructions for the processes can be stored in any of a variety of non-transitory computer readable media appropriate to a specific application.

### Server System

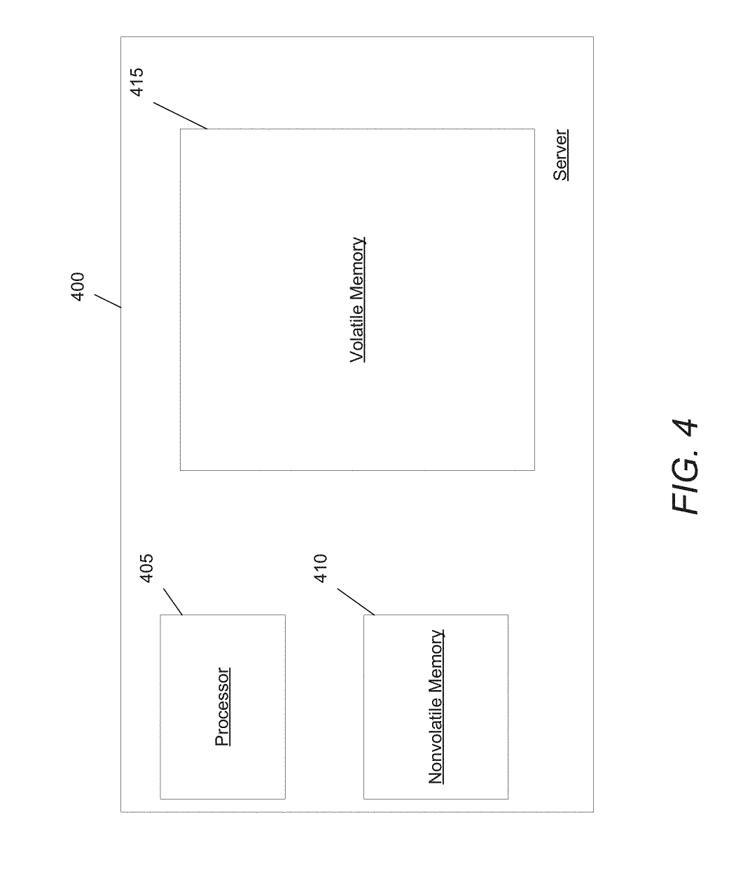

Processes that provide methods and systems for encoding video content from each of two or more camera and/or views into alternative streams for adaptive bitrate streaming using multiple encoders in accordance with an embodiment of this invention are performed by an encoder system such as an encoding server. The relevant components in an encoding server that perform these processes in accordance with an embodiment of the invention are shown in FIG. 4. Servers in accordance with various other embodiments may include other components that are omitted for brevity without departing from various embodiments of this invention. The server 400 includes a processor 405, a non-volatile memory 410, and a volatile memory 415. The processor 405 can be a processor, microprocessor, controller, or a combination of processors, microprocessor, and/or controllers that performs instructions stored in the volatile 415 and/or non-volatile memory 410 to manipulate data stored in the memory. The non-volatile memory 410 can store the processor instructions utilized to configure the server 400 to perform processes including processes for encoding media content and/or generating marker information in accordance with some embodiments of the invention and/or data for the processes being utilized. In accordance with many embodiments, these instructions may be in server software and/or firmware and can be stored in any of a variety of non-transitory computer readable media appropriate to a specific application. Although a specific server is illustrated in FIG. 4, any of a variety of servers configured to perform any number of processes can be utilized in accordance with various embodiments of the invention.

Encoding of Video Content from Two or More Cameras into Alternative Streams for Adaptive Bitrate Streaming Using an Encoding System

In accordance with some embodiments of the invention, an encoding system encodes video content from each of two or more cameras and/or views into alternative streams for adaptive bitrate streaming using multiple encoders. In accordance with many embodiments, the encoders can be software encoders that are instantiations of software instructions read from a memory that can be performed or executed by a processor. Software encoders may be used when it is desirable to reduce the cost of the encoders and/or to improve the scalability of the system as only processing and memory resources are needed to add additional encoders to the system. In accordance with a number of embodiments, one or more of the multiple encoders can be hardware encoders. Hardware encoders are circuitry that is configured to perform the processes for encoding the received content into one or more streams. In accordance with several embodiments, one or more of the encoders may be firmware encoders. A firmware encoder combines some hardware components and some software processes to provide an encoder.

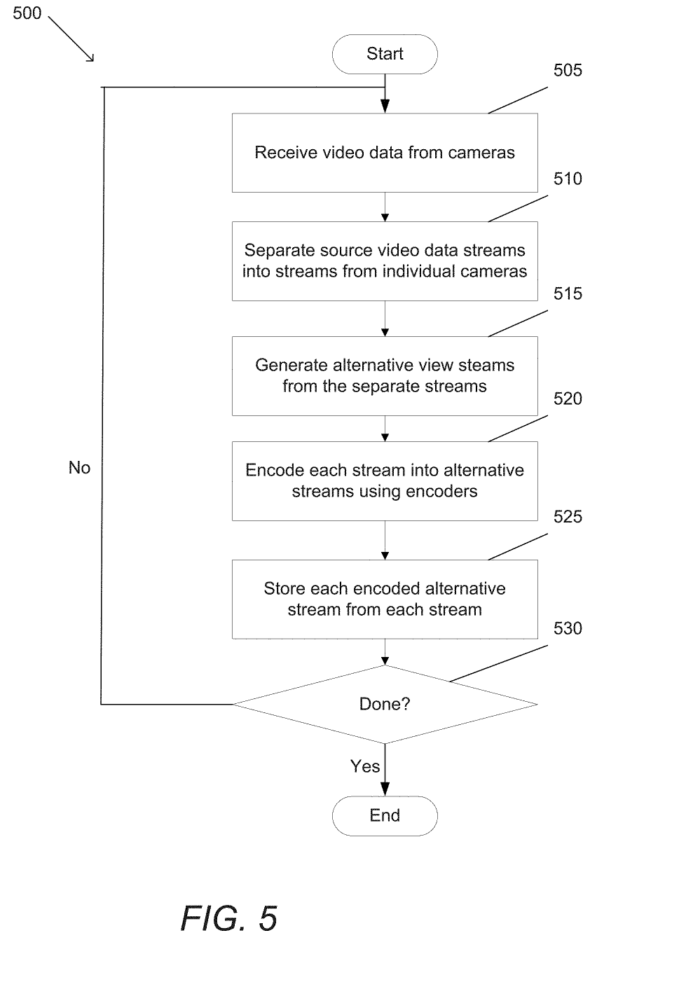

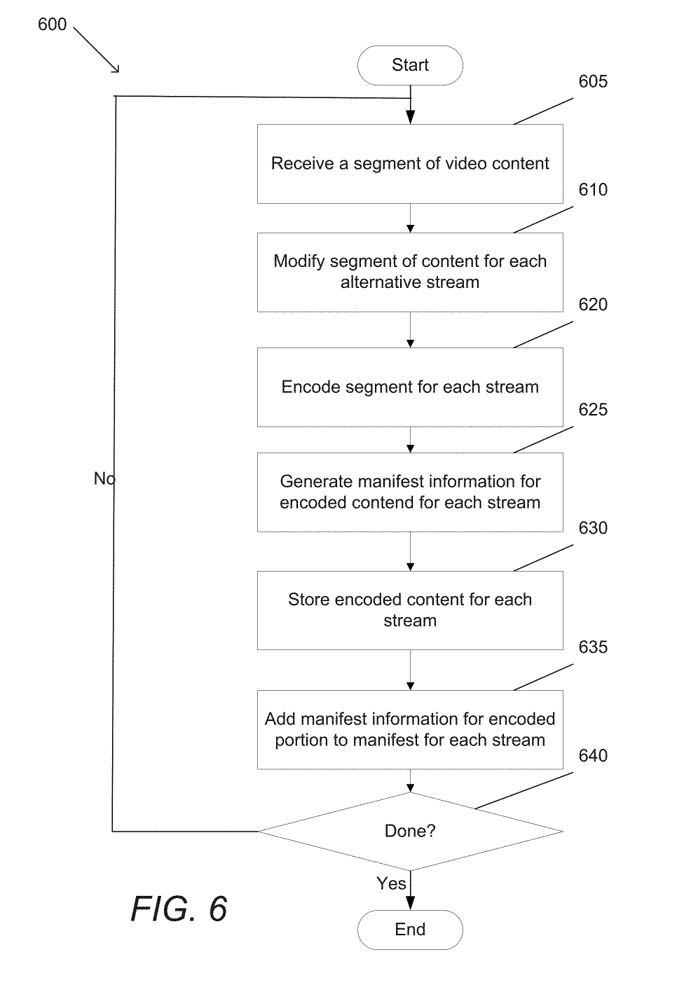

The video content from each of two or more cameras may be received as a single source stream or multiple streams from a content provider. In accordance with some embodiments, the video content from each of the two or more cameras can be a live broadcast meaning the video content is being captured and streamed in real time. The video content may include time information. The time information may include, but is not limited to, a broadcast time, a presentation time and/or a recordation time. In accordance with many embodiments, the encoder system receives the source streams from each of the two or more cameras and provides each stream to a particular encoder or group of encoders. Each of the encoders or groups of encodes can receive the source stream of video content for a camera and/or a view; and can generate portions of the alternative streams. In accordance with some embodiments, the encoding system may receive the streams from the two or more cameras in one source stream and divides the video content captured by each camera in the source stream into separate streams of video content from each camera. In accordance with many embodiments, each of the multiple encoders or groups of encoders can produce a single set of alternative streams for a stream of video content from a particular camera and/or view. In accordance with a number of embodiments, the encoding system may perform processing to generate streams for one or more views from the streams of video content from the one or more cameras. In a number of embodiments, the encoding system may generate one 360° video stream from the streams of video content from each of the 2 or more cameras and divide the 360° video stream into tiles for use in generating particular views. Processes for encoding alternative streams of video content from each source stream of video content from the two or more cameras and different views in accordance with some different embodiments of the invention are shown in FIGS. 5 and 6.

A flow chart of a process performed by an encoding system to encode video content from each of two or more cameras and/or views into alternative streams for use in adaptive bitrate streaming in accordance with an embodiment of the invention is shown in FIG. 5. In process 500, the encoder receives a portion of a source stream of video content that includes video content from each of two or more cameras (505). The encoder separates the source stream of video content from the two or more cameras into individual sources streams of video content for each of the two or more cameras (510). In accordance with some embodiments, video content from the individual cameras may be received in individual streams and the separation is not needed.

The source encoder system may process the video content from video streams of the two more cameras to generate video content for one or more points of view that are different from the points of view of the two or more cameras (515). In a number of these embodiments, the processing may include generating a stream of 360° video content from the video content captured by the two or more streams and dividing the 360° video content into separate tiles in which each tile is a separate source stream. While each tile can constitute a separate source stream, the tiles may encode overlapping regions of the original 360° video content to enable smooth transitions between adaptation sets for adjacent viewpoints within the 360° view of the content. As can readily be appreciated, the number of tiles used to encode the 360° video content and the extent of overlap between tiles (if any) is largely dependent upon the requirements of a specific application.

Each video content stream can be provided to a particular encoder or group of encoders that encodes each source stream in multiple alternative streams for use in adaptive bitrate streaming (520). In accordance with some embodiments, two or more of the generated streams of video content from each particular camera and/or view are encoded at different maximum bitrates. In accordance with some other embodiments, the two or more of the alternative streams for video content from a particular one of the two or more cameras and/or views have the same maximum bitrate and different video parameters including, but not limited to different aspect ratios, resolutions, and/or frame rates. The encoder also generates index or manifest information for the generated segment(s). The generated segment(s) for each stream can be stored in a single container file storing the segments of a particular stream (525) or separate container files and the index or manifest information can be added to a manifest or index file for the video content stored in memory and/or placed in separate files referenced by a manifest file. In a number of embodiments where the streams are from a live broadcast, the manifest or index information may be delivered to client playback devices as an update. Process 500 repeats until the encoder receives the end of the source stream(s) and/or reception of the source stream(s) is halted in some other manner (530).

Although various embodiments of processes performed by an encoder for encoding alternative streams of video content for the video content from each of two or more cameras and/or views are described above, processes in accordance with various other embodiments that add, remove, and/or combine steps of the encoding process to in accordance with system requirements are possible.

In accordance with some embodiments of the invention, each encoder or group of encoders divides the source stream of video content from one of the camera or views into segments and generates segments of the alternative streams for the video content. A flow diagram of a process performed by each encoder or group of encoders to generate the multiple alternative streams of the video content from one of the two or more cameras and/or views in accordance with an embodiment of the invention is shown in FIG. 6.

In process 600, the encoder or group of encoders receive a portion of a source stream of video content from one of the at least two cameras or views (605). In accordance with some embodiments, the portion includes timing information. In accordance with many embodiments, the encoder or group of encoders may use the time information received with the portion to determine a point in the stream that the encoder is to start encoding the stream. As the encoders for all of the source streams are using the same timing information, the encoding performed by the encoders can be synchronized such that the segments produced by each encoder may include the same duration of video content to present in terms of presentation time and the segments are aligned in accordance with a number of embodiments.

The encoder can modify the video content from the received portion of the stream in accordance with properties of each of the alternative streams to generate segments for each of the alternative streams (610). In accordance with some embodiments, two or more of the alternative streams of video content from each particular camera and/or view may be encoded at different maximum bitrates. In accordance with some other embodiments, the two or more of the alternative streams of video content from each particular camera and/or view may be encoded at the same maximum bitrate but with different video parameters. In accordance with a number of embodiments, the video parameters include, but are not limited to, aspect ratio, resolution, and/or frame rate. In many embodiments, different maximum bitrates are achieved by encoding the video with different video parameters. Each generated segment for each particular alternative stream can be encoded (620) and manifest information for each generated segment can be generated (625). The encoded segment for each alternative stream can be stored in a container file associated with the alternative stream of the segment (630) and the manifest information can be added to a manifest or index file associated with the particular alternative stream of the segment (635). In accordance with many embodiments, the manifest or index information generated by a particular encoder may be added to an MPD for the segments encoded by the particular encoder. In a number of embodiments, the manifest or index information can be delivered to client playback devices as an update. Process 600 repeats until the encoder receives the end of the stream and/or reception of the stream is halted in some other manner (640).

Although various examples of processes performed by an encoder for encoding the alternative streams of video content for video content from each of two or more cameras or views in accordance with various embodiments of the invention are described above, other processes for encoding the portions for the streams in accordance with various other embodiments that add, combine and/or remove steps in accordance with system requirements may be performed.

### Process Performed by a Playback Device to Obtain Video Content Using Alternative Streams Generated by Multiple Encoders

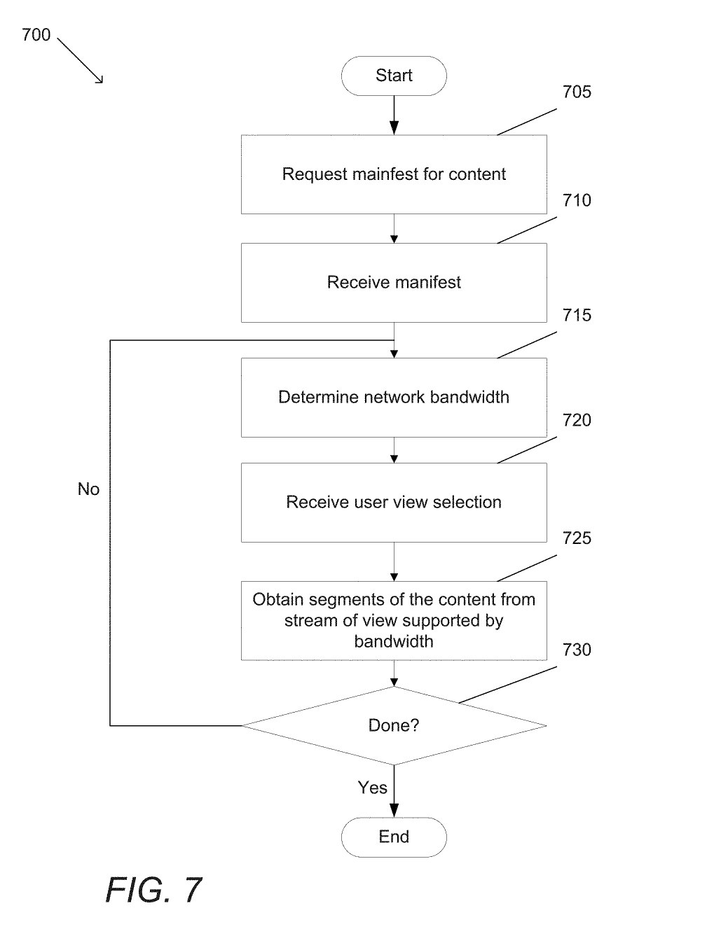

In accordance with some embodiments of the invention, a playback device uses the alternative streams for the video content from each of the two or more cameras and/or views for playback. In many embodiments, the playback devices uses adaptive bit rate streaming to obtain the media content from the alternative streams generated using multiple encoders. To do so, the playback device may receive manifest information (e.g. a MPD) generated by the encoders for use in obtaining the segments during adaptive bit rate streaming. A process performed by a playback device to perform adaptive bitrate streaming in accordance with an embodiment of the invention is shown in FIG. 7.

In process 700, the playback device requests the MPD, index, or manifest that provides information for the video content (705). The playback device receives the MPD, index, or manifest that includes the information for the alternative streams of the video content from each of the two or more cameras and/or views (710). The playback device determines the network bandwidth (715). The determination of the network bandwidth may be performed in one of any number of known manners in accordance with various embodiments of the invention.

The desired view or camera from which to receive view the video content is determined (720). In accordance with various embodiments, the playback device may determine the desired view or camera in any number of manners including, but not limited to, detected movement of the playback device; the use of an image of the device and/or user captured from another device to determine point of view; and/or motion data or other metadata received with the video content. The playback device can use the network bandwidth and the desired view or camera to select one of the alternative streams to use in adaptive streaming to obtain video content for the desired view or camera. The playback device can obtain segments of the video content for the desired camera and/or view using the determined stream (725). In accordance with some embodiments of the invention, the playback device may monitor the network bandwidth based on communications over the network between the playback device and the content provider system. The playback device may select other streams of the audio and/or video content of the desired view that are encoded at highest maximum bitrates that can be handled by the playback device given the current network bandwidth using adaptive bit rate streaming techniques until the playback is completed (730). In accordance with some embodiments, the adaptive bit rate streaming performed by the playback device may be in accordance with the processes described in U.S. Patent Application Publication 2013/0007200 entitled “Systems and Methods for Determining Available Bandwidth and Performing Initial Stream Selection When Commencing Streaming Using Hypertext Transfer Protocol” and U.S. Pat. No. 8,832,297 entitled “Systems and Methods for Performing Multiphase Adaptive Bitrate Streaming,” the disclosures of which are hereby incorporated by reference in their entirety. More particularly, the processes performed by a playback device to obtain the video content using adaptive bit rate streaming described in these references are incorporated herein by reference. Process 700 is then periodically repeated until the end of the video content is reached or the presentation is interrupted in some other manner (730).

It is to be understood that the present invention may be practiced in other manners than those specifically described above, including various changes in the implementation such as utilizing encoders and decoders that support features beyond those specified within a particular standard with which they comply, without departing from the scope and spirit of the present invention. Thus, embodiments of the present invention discussed above should be considered in all respects as illustrative and not restrictive.

What is claimed is:

1. A playback device comprising:
a processor;
memory accessible by the processor; and
instructions stored in the memory that direct the processor to:
request video content from a content provider system,
receive a manifest including information for retrieving plurality of alternative streams of video content from a content provider system, wherein each of a plurality of alternative streams includes segments of video content for one of a plurality of views of the video content and is encoded at a specific maximum bit rate,
determine a network bandwidth for communications between the playback device and content provider system,
determine a desired view of the video content,
determine one of the plurality of alternative streams to use for streaming based on the determined network bandwidth and the desired view and the information for the plurality of alternative streams in the manifest,
request segments of video content from the determined one of the plurality of alternative streams based on information for the one of the plurality of alternative streams in the manifest from the content provider system,
receive the requested segments from the determined one of the plurality of alternative streams from the content provider system in response to the request, and
playback the received segments.

2. The playback device of claim 1 wherein the instructions further direct the processor to:
monitor communications between the playback device and the content provider system;
detect a change in the network bandwidth to a new network bandwidth based on the monitored communications;
determine a second one of the plurality of alternative streams to use for streaming based on the new network bandwidth and the desired view using the manifest;
request segments of the video content from the second one of the plurality of alternative streams from the content provider system based on information for the second one of the plurality of alternative streams in the manifest from the content provider system;
receive the requested segments from the second one of the plurality of alternative streams from the content provider system in response to the request; and
playback the received segments.

3. The playback device of claim 1 wherein the instructions further direct the processor to:
determine a change in view of the video content to a second view is desired;
determine a second one of the plurality of alternative streams to use for streaming based on the network bandwidth and the second view using the manifest;
request segments of the video content from the second one of the plurality of alternative streams from the content provider system based on information for the second one of the plurality of alternative streams in the manifest;
receive the requested segments of the second one of the plurality alternative streams from the content provider system in response to the request; and
playback the received segments.

4. The playback device of claim 1 wherein the determining of the view is based upon detected movement of the playback device.

5. The playback device of claim 1 wherein the determining of the view is based upon an image of the playback device captured from another device to determine point of view.

6. The playback device of claim 1 wherein the determining of the view is based upon metadata received with the video content.

7. A method of providing playback of video content from one of a plurality of views using a playback device comprising:
requesting video content from a content provider system using the playback device;
receiving a manifest including information for retrieving a plurality of alternative streams of video content in the playback from a content provider system, device wherein each of a plurality of alternative streams includes segments of video content for one of a plurality of views of the video content and is encoded at a specific maximum bit rate;
determining a network bandwidth for communications between the playback device and content provider system using the playback device;
determining a desired view of the video content using the playback device;
determining one of the plurality of alternative streams to use for streaming based on the determined network bandwidth, the desired view, and the information for the plurality of alternative streams in the manifest using the playback device;
requesting segments of video content from the determined one of the plurality of alternative streams based on information for the one of the plurality of alternative streams in the manifest from the content provider system using the playback device;
receiving the requested segments of the one of the plurality of alternative streams from the content provider system in the playback device in response to the request; and
playing back the received segments using the playback device.

8. The method of claim 7 further comprising:
monitoring communications between the playback device and the content provider system using the playback device;
detecting a change in the network bandwidth to a new network bandwidth using the playback device;
determining a second one of the plurality of alternative streams to use for streaming based on the new network bandwidth and the desired view using the manifest using information in the manifest;
requesting segments of the video content from the second one of the plurality of alternative streams from the content provider system based on information for the second one of the plurality of alternative streams in the manifest using the playback device;
receiving the requested segments of the second one of the plurality of alternative streams from the content provider system in the playback device in response to the request; and
playing back the received segments using the playback device.

9. The method of claim 7 further comprising:
determining a change in view of the video content to a second view is desired using the playback device;
determining a second one of the plurality of alternative streams to use for streaming based on the network bandwidth and the second view based on information in the manifest the manifest using the playback device;
requesting segments of the video content from the second one of the plurality of alternative streams from the content provider system based on information for the second one of the plurality of alternative streams in the manifest using the playback device;
receiving the requested segments of the second one of the plurality of alternative streams from the content provider system in the playback device in response to the request; and
playing back the received segments using the playback device.

10. The method of claim 7 wherein the determining of the view is based upon detected movement of the playback device.

11. The method of claim 7 wherein the determining of the view is based upon an image of the playback device captured from another device to determine point of view.

12. The method of claim 7 wherein the determining of the view is based upon metadata received with the video content.

13. A non-transitory machine readable medium that stores instructions for directing a processing unit to perform a method for playing back video content comprising:
requesting video content from a content provider system;
receiving a manifest including information for retrieving a plurality of alternative streams of video content from a content provider system, wherein each of a plurality of streams includes segments of video content for one of a plurality of views of the video content and is encoded at a specific maximum bit rate;
determining a network bandwidth for communications between the playback device and content provider system;
determining a desired view of the video content;
determining one of the plurality of alternative streams to use for streaming based on the determined network bandwidth, the desired view, and the information for the plurality of alternative streams in the manifest;
requesting segments of video content from the determined one of the plurality of alternative streams based on information for the one of the plurality of alternative streams in the manifest from the content provider system;
receiving the requested segments of the one of the plurality of alternative streams from the content provider system in response to the request; and
playing back the received segments.

14. An encoding system for generating a plurality of alternative streams of video content from video content captured from a plurality of cameras comprising:
a processor;
a memory accessible by the processor; and
instructions stored in memory that direct the processor to:
obtain at least one stream of video content containing video captured by one of a plurality of cameras and each of the plurality of cameras has a different view point,
provide video content from the at least one stream to a plurality of encoders wherein the plurality of encoders encode each of a plurality of separate viewpoints from within the video content into an adaptation set comprising a plurality of alternatives streams,
generate index information for the adaption set corresponding to each of the plurality of separate viewpoints,
store each of the generated adaptation sets in memory, and
store the manifest information for each adaptation set in a manifest, where the manifest indicates a maximum bitrate for each of the plurality of streams in an adaptation set and a viewpoint for each adaptation set.

15. The encoding system of claim 14 wherein the instructions to obtain the plurality of streams of video content include instructions to:
receive a source stream of video content captured by the plurality of cameras; and
divide the source stream into a plurality of streams wherein each of the plurality streams includes video content from one of the plurality of cameras;
wherein the plurality of streams of the video content from the plurality of cameras are provided to the encoders.

16. The encoding system of claim 14 wherein the instructions to obtain the plurality of streams of video content include instructions to:
receive a source stream of video content captured by the plurality of cameras;
generate 360° degree view video content from the video content of the source stream; and
divide the 360° degree view video content into a plurality of tiles wherein each of the plurality of tiles is a stream of video content from a specific viewpoint;
wherein the plurality of tiles are provided to the encoders.

17. The encoding system of claim 14 wherein the instructions to obtain the plurality of streams include instructions to receive each of the plurality of streams for one of the plurality of cameras and wherein each of the received plurality of streams is provided to the plurality of encoders.

18. The encoding system of claim 14 wherein the instructions that direct the processor further include instructions to:
provide an encoder that receives an input stream of video content and outputs video content for a plurality of alternative streams wherein each of the plurality alternative streams is encoded at a different maximum bit rate and the instructions to provide the encoder are scalable to the plurality of encoders by instantiating a plurality of encoders from the instructions to provide the encoder.

19. The encoding system of claim 14 wherein the plurality of streams of video content provided to the plurality of encoders include timing information for the video content and the encoding of the video content into a plurality of alternative streams by the plurality of encoders is synchronized based on the timing information in the plurality of streams of video content.

20. An encoding system for generating a plurality of alternative streams of video content from video content captured from a plurality of cameras comprising:
obtaining at least one stream of video content containing video captured by one of a plurality of cameras and each of the plurality of cameras has a different view point,
providing video content from the at least one stream to a plurality of encoders wherein the plurality of encoders encode each of a plurality of separate viewpoints from within the video content into an adaptation set comprising a plurality of alternatives streams;
generating index information for the adaption set corresponding to each of the plurality of separate viewpoints;
storing each of the generated adaptation sets in memory; and
storing the manifest information for each adaptation set in a manifest, where the manifest indicates a maximum bitrate for each of the plurality of streams in an adaptation set and a viewpoint for each adaptation set.

21. The method of claim 20 wherein the obtaining of the plurality of streams of video content comprises:
receiving a source stream of video content captured by the plurality of cameras in the encoding system; and
dividing the source stream into a plurality of streams using the encoding system wherein each of the plurality streams includes video content from one of the plurality of cameras;
wherein the plurality of streams of the video content from the plurality of cameras are provided to the encoders.

22. The method of claim 20 wherein the obtaining of the plurality of streams of video content comprises:
receiving a source stream of video content captured by each of the plurality of cameras in the encoding system;
generating 360° degree view video content from the video content of the source stream using the encoding system; and
dividing the 360° degree view video content into a plurality of tiles using the encoding system wherein each of the plurality of tiles is a stream of video content from a particular view;
wherein the plurality of tiles are provided to the encoders.

23. The method of claim 20 wherein the obtaining of the plurality of streams includes receiving each of the plurality of streams for one of the plurality of cameras in the encoder system and wherein each of the received plurality of streams is provided to the plurality of encoders.

24. The method of claim 20 wherein the plurality of streams of video content provided to the plurality of encoders include timing information for the video content and the encoding of the video content into a plurality of alternative streams by the plurality of encoders is synchronized based on the timing information in the plurality of streams of video content.
